(19) United States
(12) Patent Application Publication
(10) Pub. No.: US 2006/0097583 A1
(43) Pub. Date: May 11, 2006

(54) Electromechanical transducers

(76) Inventor: Mark Alexander Dodd, Suffolk (GB)

Correspondence Address: Myers Dawes Andras & Sherman, 19900 MacArthur Blvd, 11th Floor, Irvine, CA, 92612, US

(21) Appl. No.: 10/528,551

(22) PCT Filed: Sep. 19, 2003
(86) PCT No.: PCT/GB03/04032

§ 371 Date: Sep. 2, 2005

(30) Foreign Application Priority Data
Sep. 21, 2002 (GB) 0221995.4

(51) Int. Cl. H01F 7/08; H04R 9/06; H02K 41/00

(52) U.S. Cl. 310/12; 335/222; 381/400; 381/396

(57) ABSTRACT

A drive assembly for a loudspeaker comprises a permanent magnet (42) and pole pieces (44a, 44b, 44c, 44d, 4e, 44f, 44g, 44h, 46a, 46b, 46c, 46d) of ferromagnetic material. The pole pieces define an air gap (43) in which a coil formed from windings (40a, 40b) on a former (41) is movable. The shaping of the pole pieces to form air-filled recesses extending to the air gap has the result that the path of the magnetic flux of the permanent magnet is split in the region of the gap and the magnetic permeability of the path of the magnetic flux of the secondary magnetic field induced in the coil upon energisation thereof is reduced. The effect of the secondary field is thereby also reduced and a particularly linear response and a reduction in harmonic distortion can thereby be achieved.

This invention relates generally to electromechanical transducers, and is particularly concerned with electrodynamic loudspeakers.

Electrodynamic loudspeakers typically use permanent magnets within a magnetic circuit of ferromagnetic material to create magnetic flux in an air gap within which a voice coil is displaceable. The magnetic circuit directs the flux produced by the permanent magnet into the air gap. When no current flows through the voice coil, the magnetic flux in the air gap is constant. The voice coil receives signals which produce a current in the coil in a direction which is substantially perpendicular to the direction of the lines of magnetic flux produced by the permanent magnet. Thus, axial motion of the coil is produced by the force on the current-carrying coil according to well known principles. The coil is connected mechanically to a diaphragm which is driven by the axial motion of the coil produced by the motor force on the coil.

Various types of distortion can arise in the translation of a given electrical signal from an amplifier into the sound heard by a listener. A particular problem arises in relation to second harmonic and third harmonic distortion.

A further factor which is relevant to the design of loudspeakers is the length of the voice coil or voice coils in relation to the length of the air gap within which the coil or coils move. In most loudspeaker designs the length of the coil is more than the length of the air gap and the axial motion of the coil is substantially dependent on the length of the coil. The voice coil typically does not move beyond the region in which the flux density is substantially constant and perpendicular to the coil. The field adjacent the air gap adds significantly to the flux passing through the coil causing the force to vary with the position of the coil. This results in harmonic distortion at low frequencies where the displacement of the coil is significant.

In the case of a short or “underhung” coil, magnetic modulation distortion can occur which affects the linearity of response of the loudspeaker. The magnetic field which is generated by the voice coil modulates the field in the air gap which interacts with the current voice coil to generate the driving force. In the air gap there are two magnetic fields, one generated by the voice coil and one generated by the permanent magnet. These fields are not superimposed but are added to each other. This causes distortion, particularly second harmonic and third harmonic distortion, because the driving force will vary depending upon the incoming signal to the voice coil. This is particularly so at low frequencies.

Attempts have been made to solve these problems by using a short voice coil within a long air gap. However, although this is a customary design, it has only limited effectiveness.

It is also known to try to overcome this problem by creating eddy currents in the magnetic circuit to produce a magnetic field which opposes the magnetic field generated by the voice coil. This can help to reduce the variations in magnetic flux to some extent.

It is further known to stabilise the magnetic flux profile by setting conductive rings into the pole piece. With the correct length of coil this does give some improvement in reducing distortion. However, in these arrangements, the flux through the voice coil and the flux within the magnetic circuit are not ideal. Also, the resistance and skin effects of the conductive rings limit the eddy currents. Moreover, at low frequencies, the flux produced by the coil does not induce sufficient current in the conductive rings to stabilise the flux and these flux stabilization measures thus become ineffective at low frequencies.

International patent application WO-A-91/05447 describes an electrodynamic speaker in which a shorted turn is positioned in the air gap to reduce the inductance that the loudspeaker presents as a load to a driving source and to increase the fidelity of reproduction of an input signal.

International patent application WO-A-89/02501 describes a magnetic circuit for an electromechanical transducer, such as a loudspeaker, in which compensating coils or compensating conductors are provided within grooves formed in the surface of the pole pieces of the magnetic circuit. These compensating coils or conductors are supplied with a current corresponding to the signal current, in order to produce an opposing magnetic field to that produced by the voice coil.

None of these known designs and structures is able significantly to reduce second harmonic and third harmonic distortion at low frequencies. Thus, prior art devices possess deficiencies which detract from their overall effectiveness and desirability.

As such, although the prior art has recognized, to a limited extent, the problem of undesirable second and third harmonic distortion at low frequencies, the proposed solutions have, to date, been ineffective in providing a satisfactory remedy.

In view of the foregoing, it is desirable to provide an electromechanical transducer, particularly an electrodynamic loudspeaker, in which second harmonic and third harmonic distortion is significantly reduced, especially at low to mid-range frequencies, i.e. up to about 150 Hz.

It is further desirable to provide a loudspeaker driver or linear motor which has exceptionally high linearity.

While the apparatus and method has or will be described for the sake of grammatical fluidity with functional explanations, it is to be expressly understood that, when this specification is interpreted under United States law, the claims, unless expressly formulated under 35 USC 112, are not to be construed as necessarily limited in any way by the construction of “means” or “steps” limitations, but are to be accorded the full scope of the meaning and equivalents, and in the case where the claims are expressly formulated under 35 USC 112 are to be accorded full statutory equivalents under 35 USC 112.

The present invention is based upon the recognition that the path of the magnetic flux from the voice coil through the pole pieces is not the same as the path of the magnetic flux from the permanent magnet through the pole pieces. Consequently, in accordance with the invention, the permeability of the path of the magnetic flux from the voice coil is decreased, by decreasing the permeability of the magnetic circuit. This decrease in the permeability of the magnetic circuit is achieved by splitting or dividing the magnetic circuit to make it a multi-pole circuit. This is achieved by introducing at least one separation into the magnetic circuit, thereby to create at least two, and preferably three or more poles.

This division of the magnetic circuit can be accomplished by the use of air gaps and/or rings of conductive or non-conductive material within the magnetic circuit. In this way one can create two or more poles, thus decreasing the permeability of the magnetic circuit and enabling the achievement of an ultra-linear driver.

The present invention is not limited to the use of a single voice coil within the air gap of the loudspeaker. The invention is also appropriate to embodiments which use two voice coils within the air gap.

A further advantage of the present invention is that the choice of coil length and gap length is less critical. One can even use a long coil within a short gap, although there will be some flux modulations with such a configuration.

The present invention accordingly provides an electromechanical drive assembly, comprising

a magnet structure which comprises at least one permanent magnet and is shaped to define an air gap; and

a cylindrical coil which is received in the gap and movable axially therein relative to the magnet structure, the coil comprising at least one coil winding;

wherein:

the material and/or the shape of the magnet structure is such that the path of the magnetic flux of the permanent magnet is split.

Thus, in an assembly according to the invention, by the design of the magnet structure, the magnetic permeability of the path of the magnetic flux of the secondary magnetic field induced in the coil upon energisation thereof is reduced compared with the permeability which it would have had if the path of the magnetic flux of the permanent magnet had not been split. The effect of the secondary magnetic field on the response of assembly is thereby reduced and a more linear response attained.

The surfaces of the magnet structure defining the gap may be shaped so that the path of the magnetic flux of the permanent magnet is split in the region of the gap.

This may be achieved by dividing the magnet structure into a plurality of separate pole pieces with air gaps therebetween.

Alternatively, the material of the magnet structure defining the gap may be chosen so that the path of the magnetic flux of the permanent magnet is split in the region of the gap.

This may be achieved by provision of inserts of non-magnetic material in the magnet structure.

Thus, the magnet structure may have in at least one of its surfaces defining the air gap at least one annular recess which extends to the gap.

Alternatively or additionally, at least one of the surfaces of the magnet structure defining the air gap is formed from a material of reduced magnetic permeability relative to the remainder of the magnet structure.

Conveniently, the magnet structure comprises at least one permanent magnet and at least one pole piece of ferromagnetic material.

The gap may be defined entirely by the pole piece(s) or, alternatively, may be defined in part by the pole piece(s) and in part by the magnet(s).

The magnet(s) and/or the pole piece(s) may be shaped to define at least one annular recess in the magnet structure which extends to and merges with the air gap.

Preferably, the pole piece(s) is/are shaped so that the or at least one recess extends from the air gap to the permanent magnet.

Alternatively, the magnet structure comprises at least one piece of material of reduced magnetic permeability relative to the pole piece(s), the or at least one piece of reduced permeability material being annular in shape and extending from the air gap, where it defines a portion of the surface thereof, to the permanent magnet(s).

Advantageously, alternate annular portions of an inner surface of the air gap are formed from the magnet structure and from a material of reduced magnetic permeability relative to the remainder of the magnet structure.

Also advantageously, alternate annular portions of an outer surface of the air gap are formed from the magnet structure and from a material of reduced magnetic permeability relative to the remainder of the magnet structure.

Preferably, the annular portions of the inner surface are aligned across the gap with the annular portions of the outer surface.

In another advantageous arrangement, the surface of the magnet structure defining an inner surface of the air gap is shaped so that the inner surface of the air gap is interrupted by a plurality of annular recesses which extend to and merge with the gap.

It is also advantageous if the surface of the magnet structure defines an outer surface of the air gap which is shaped so that the outer surface of the air gap is interrupted by a plurality of annular recesses which extend to and merge with the gap.

Preferably, the inner annular recesses are aligned across the gap with the outer annular recesses.

In a preferred assembly, alternate annular portions of one of the inner and the outer surfaces of the air gap are formed from the magnet structure and from a material of reduced magnetic permeability relative to the remainder of the magnet structure and the surface of the magnet structure defining the other of the inner and the outer surface of the air gap is shaped so that the said other surface of the air gap is interrupted by a plurality of annular recesses which extend to and merge with the gap, the annular portions of reduced magnetic permeability being aligned across the gap with the annular recesses.

Preferably, there are at least two said annular portions of reduced permeability or at least two said annular recesses in each cylindrical wall of the air gap.

More preferably, there are at least four said annular recesses extending to and merging with the air gap.

Conveniently, the coil comprises a former on which are formed two or more axially-spaced coil windings.

Preferably, axial extent of the winding(s) is less than the axial extent of the air gap.

The assembly may comprise first and second permanent magnets which are spaced-apart in the axial direction of the air gap.

In another assembly according to the invention, first, second and third permanent magnets are spaced-apart in the axial direction of the air gap.

Conveniently, the magnet structure and the voice coil are substantially cylindrically symmetric.

In a preferred assembly, the magnet structure comprises a plurality of generally-conical pole pieces which are arranged about a common axis and nested within one another with air spaces therebetween, the outer edges of the pole pieces defining the inner wall of the air gap.

The air gap and the coil are preferably each cylindrical.

The invention also provides a magnet and coil assembly comprising at least one magnetic circuit which is split so as to mitigate a permeability thereof; and a magnet and coil assembly comprising:

at least one magnet;

at least one coil; and

at least one magnetic circuit between the magnet(s) and the coil(s), at least one of the magnetic circuit(s) being split so as to mitigate a permeability thereof. A cone is preferably attached to the coil to form a loudspeaker, the coil then being a voice coil.

The present invention specifically addresses and alleviates the above mentioned deficiencies associated with the prior art. According to one aspect, the present invention comprises a magnet/voice coil assembly comprising at least one magnetic circuit which is split so as to mitigate a permeability thereof to flux generated by the coil.

The magnetic circuit is preferably split so as define two, three, four, or more poles. The split in the magnetic circuit may be defined by at least one of an air gap, a conductive member, or a non-conductive member. Any desired combination of air gaps, conductive members, and/or non-conductive members may be utilized.

Any conductive members preferably comprised either aluminum or copper. However, those skilled in the art will appreciate that various other conductive members are likewise suitable.

The air gaps, conductive members, or non-conductive members used to define the split(s) in the magnetic circuit are preferably configured so as to generally define rings. However, those skilled in the art will appreciate that various other configurations of the air gaps, conductive members, and/or non-conductive members are likewise suitable.

The voice coil is preferably disposed within an air gap. The voice coil preferably has a length which is greater than a length of the air gap within which the voice coil is disposed.

The magnet/voice coil assembly of the present invention may be disposed generally within a housing and may have a driver attached to the voice coil, so as to define a linear motor. The driver may comprise a mechanical link or member which is suitable for communicating mechanical motion from the voice coil to the desired driven element. However, for example, the driver may comprise a driver bar or any other desired structure.

According to one aspect, the present invention comprises a speaker. Thus, the magnet/voice coil assembly comprises at least one magnet and at least one voice coil, wherein a speaker cone is attached to or otherwise in mechanical communication with the voice coil. At least one magnetic circuit between the magnet(s) and the voice coil(s). is split so as to mitigate a permeability thereof.

According to one aspect, the present invention comprises a method for operating a magnet/voice coil assembly. The method comprises facilitating movement of at least one voice coil via at least one magnet, wherein a magnetic circuit between the magnet(s) and the voice coil(s) is split.

According to one aspect, the present invention comprises a method for converting an electrical signal into sound. The method comprises facilitating movement of at least one voice coil via at least one magnet, wherein the magnetic circuit between the magnet(s) and the voice coil(s) is split.

According to one aspect, the present invention comprises a method for providing substantially linear motion. The method comprises facilitating movement of at least one voice coil via at least one magnet, wherein a magnetic circuit between the magnet(s) and the voice coil(s) is split.

According to one aspect, the present invention comprises a method for fabricating a magnet/voice coil assembly wherein the method comprises splitting a magnetic circuit so as to mitigate a permeability thereof.

These, as well as other advantages of the present invention, will be more apparent from the following description and drawings. It is understood that changes in the specific structure shown and described may be made within the scope of the claims, without departing from the spirit of the invention.

In order that the invention may be more fully understood, a number of embodiments in accordance with the invention will now be described by way of example and with reference to the accompanying drawings. In the drawings:

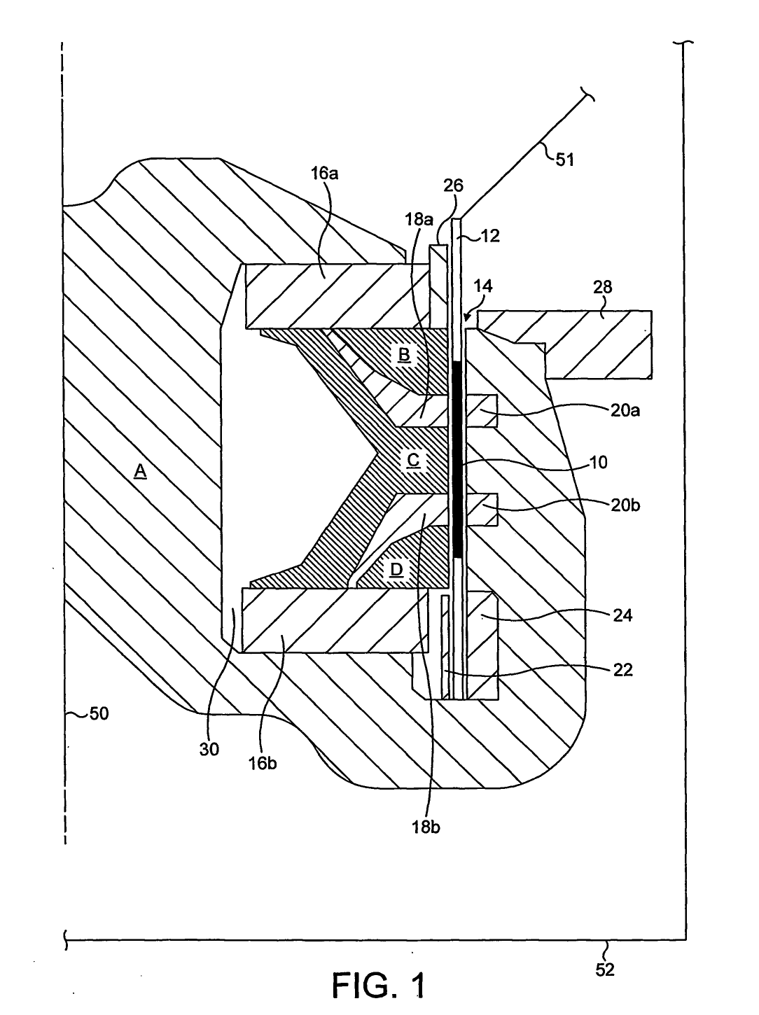

FIG. 1 is a radial cross-sectional schematic diagram showing a first embodiment of magnetic circuit for a loudspeaker in accordance with the invention;

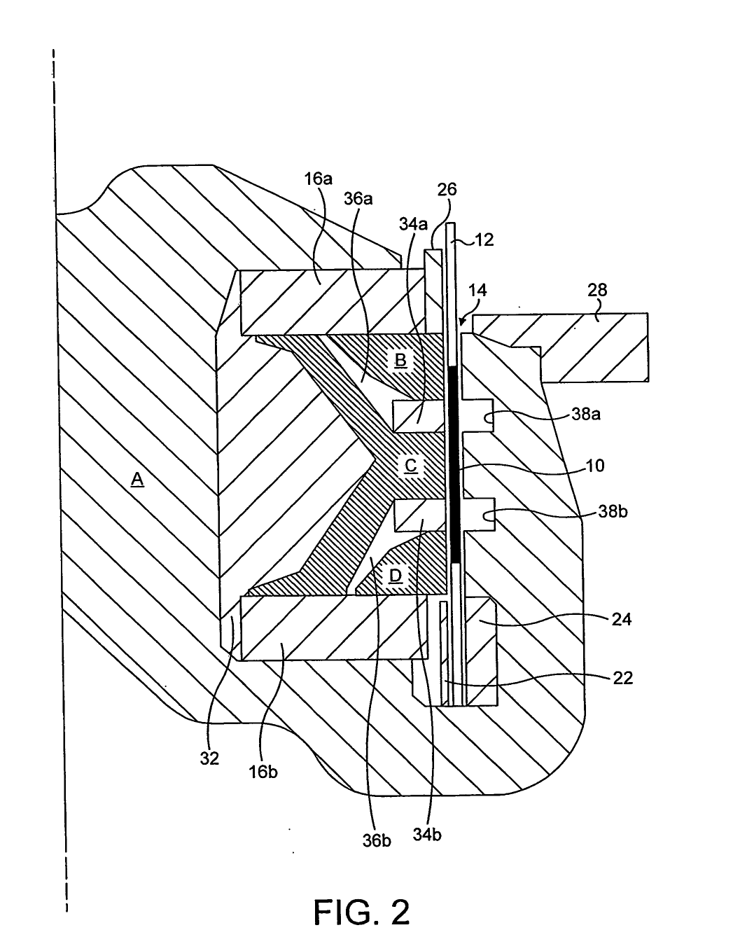

FIG. 2 is a radial cross-sectional schematic diagram of a second embodiment of magnetic circuit for a loudspeaker in accordance with the invention;

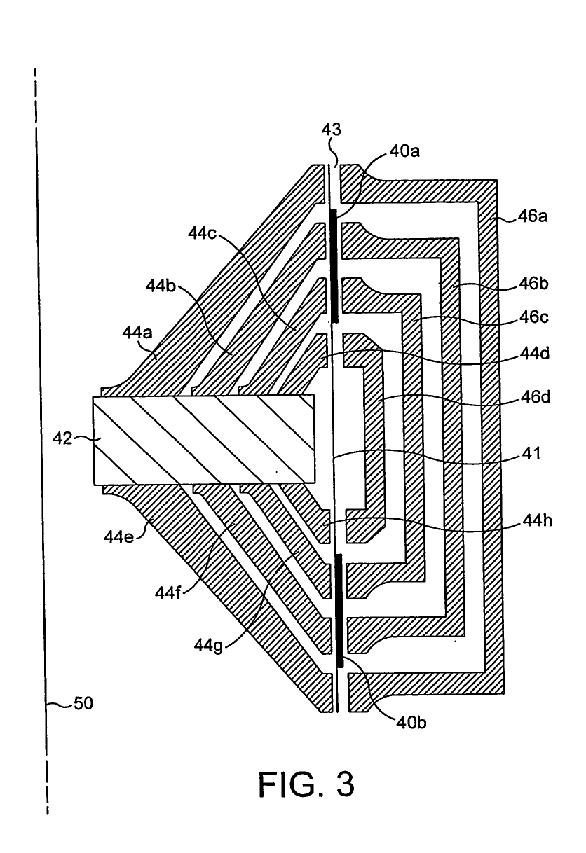

FIG. 3 is a radial cross-sectional schematic diagram of a third embodiment of magnetic circuit for a loudspeaker in accordance with the invention;

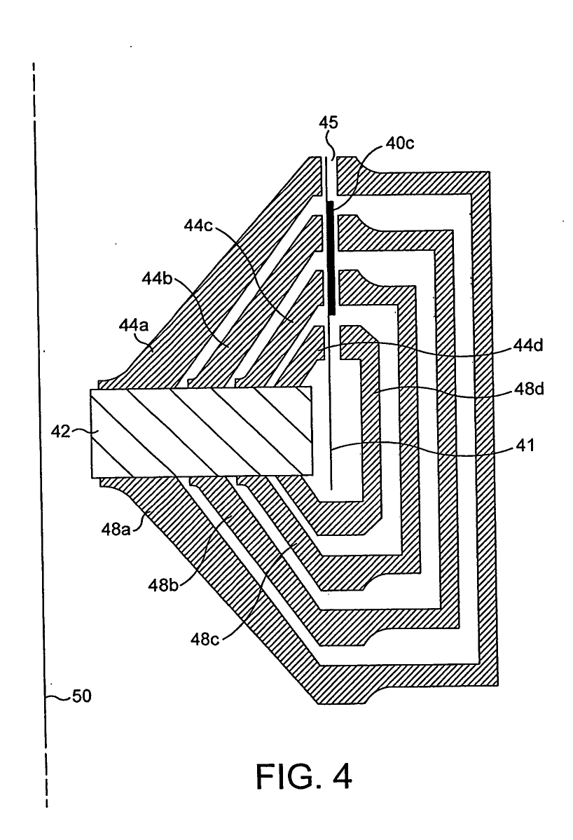

FIG. 4 is a radial cross-sectional schematic diagram of a fourth embodiment of magnetic circuit for a loudspeaker in accordance with the invention; and

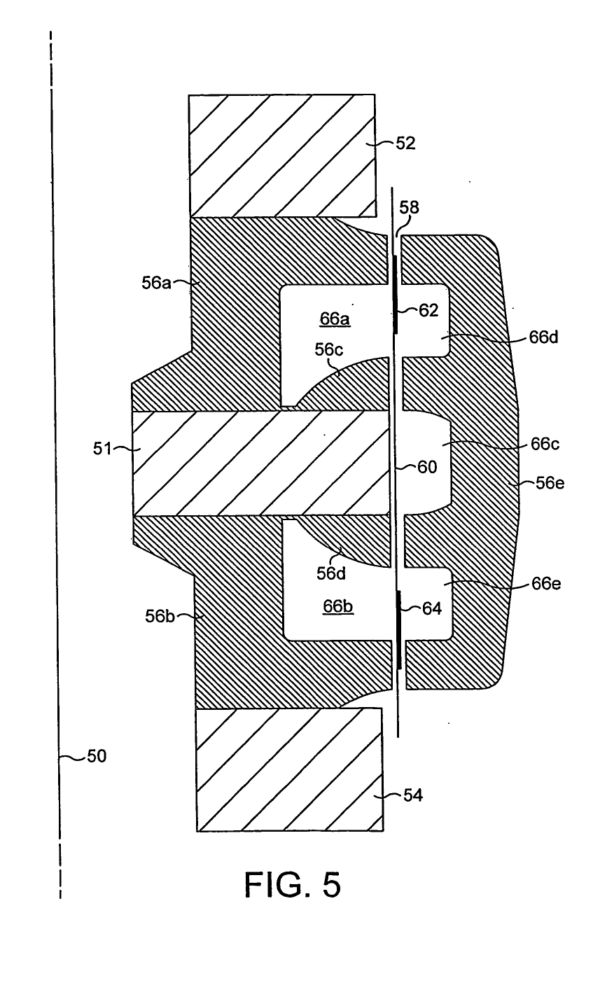

FIG. 5 is a radial cross-sectional schematic diagram of a fifth embodiment of magnetic circuit for a loudspeaker in accordance with the invention.

Many alterations and modifications may be made by those having ordinary skill in the art without departing from the spirit and scope of the invention. Therefore, it must be understood that the illustrated embodiments have been set forth only for the purposes of example and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claim subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilised. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

The present invention is illustrated in FIG. 1, which depicts a presently preferred embodiments thereof.

The present invention is based upon the recognition that the path of the magnetic flux from the voice coil through the pole pieces is not the same as the path of the magnetic flux from the permanent magnet through the pole pieces. Consequently, in accordance with the invention, the permeability of the path of the magnetic flux from the voice coil is decreased, by decreasing the permeability of the magnetic circuit. This decrease in the permeability of the magnetic circuit is achieved by splitting or dividing the magnetic circuit to make it a multi-pole circuit. This is achieved by introducing at least one separation into the magnetic circuit, thereby to create at least two, and preferably three or more poles.

This division of the magnetic circuit can be accomplished by the use of air gaps and/or rings of conductive or non-conductive material within the magnetic circuit: In this way one can create two or more poles, thus decreasing the permeability of the magnetic circuit and enabling the achievement of an ultra-linear driver.

The present invention is not limited to the use of a single voice coil within the air gap of the loudspeaker. The invention is also appropriate to embodiments which use two voice coils within the air gap.

Referring first to FIG. 1, there is shown the magnetic circuit of a loudspeaker, the other parts of which are not shown. The cross-section of FIG. 1 (as well as that of FIGS. 2 to 5) shows a portion of a loudspeaker magnet and voice coil assembly which is generally cylindrically symmetric about an axis, such as axis 50 in FIG. 1. However, those skilled in the art will appreciate that other configurations are likewise suitable. The assembly of FIG. 1 comprises a single voice coil 10 which is carried by a former 12 and is positioned within an air gap 14. Two permanent magnets 16a and 16b are positioned adjacent to the air gap 14, one above the voice coil and one below the voice coil. These permanent magnets 16a, 16b can be of a neodymium alloy material for example. The magnetic circuit comprises a plurality of elements of ferromagnetic material, such as mild steel. In this embodiment there are four such elements, which constitute separate pole pieces. These pole pieces are indicated at A, B, C and D. Pole piece A encompasses the permanent magnets and the air gap, while pole pieces B, C and D are positioned to one side of the air gap between the permanent magnets 16a and 16b. One thus has a multi-pole piece structure.

The assembly also includes a plurality of rings of conductive material, for example of aluminium or copper. Alternatively, rings of a non-conductive material could be used in some circumstances. Two rings 18a and 18b are positioned on the inside of the air gap 14 and separate the pole piece elements B, C and D from one another. On the outside of the air gap, directly opposite the rings 18a and 18b are conductive rings 20a and 20b. Adjacent to the bottom of the former 12 are positioned further conductive rings 22 and 24, one on the inside of the former and the other on the outside of the air gap. Adjacent to the top of the former 12 are positioned further conductive rings 26 and 28, the former on the inside of the former 12 and the latter on the outside of the former, in contact with the upper portion of the pole piece element A. An air gap 30 is left between the pole piece elements A and C, and the air gap 14 is enlarged at the bottom of the former around conductive ring 22.

The voice coil 10 effects movement of a loudspeaker cone shown in part at 51. In other applications of the actuator, the coil drives an item such as a switch, valve, or mirror and thus functions generally as a linear actuator. A housing 52 optionally encloses the components of the present invention.

Referring now to FIG. 2, in which the same or equivalent parts as in FIG. 1 are indicated by the respective same reference numerals, this shows an alternative embodiment, again using air gaps and conductive rings to separate the pole piece elements A, B, C and D from one another. In this embodiment, the air gap 30 of FIG. 1 is filled by a further ring 32 of conductive material, such as aluminium or copper. Also, the rings 18a and 18b of conductive material in FIG. 1 are here replaced by smaller rings 34a and 34b of conductive material and air gaps 36a and 36b. On the outside of the voice coil the conductive rings 20a and 20b of FIG. 1 are omitted, leaving air gap recesses 38a and 38b opposite the conductive rings 34a and 34b. The other elements of the assembly are unchanged. The cone 51 and housing 52 are not shown.

FIG. 3 shows an alternative embodiment which comprises two voice coils 40a and 40b wound on a former 41, a single permanent magnet 42 and four pole piece plates on each side of an air gap 43 within which the voice coils move. The permanent magnet 42 can again be of neodymium alloy material and the individual plates of mild steel or other ferromagnetic material. In this embodiment the individual plates 44a, 44b, 44c, 44d, 44e, 44f, 44g, 44h on the magnet side of the voice coils and the pole piece plates 46a, 46b, 46c, 46d on the outside of the voice coils are each separated by respective air gaps, without the use of conductive rings as in FIGS. 1 and 2. Such pole plates are symmetrically disposed both above and below the magnet, as shown. The cone 51 and housing 52 are not shown.

FIG. 4 shows a further embodiment which can be regarded as a modification of the embodiment of FIG. 3. In the FIG. 4 embodiment, there is a single voice coil 40c wound on a former 42. Compared with the FIG. 3 embodiment, the pole pieces of the FIG. 4 embodiment lying outwardly of the air gap are each formed in one piece with a respective one of the pole pieces lying inwardly of the air gap and, as seen in FIG. 3, below the magnet 42. Thus, in the FIG. 4 embodiment, the air gap 45 extends only part-way through the structure and pole pieces 48a, 48b, 48c, 48d extend beneath the magnet 42 (as seen in FIG. 4). The cone 51 and housing 52 are not shown.

FIG. 5 shows yet another embodiment in which there is a central magnet 51 and upper and lower magnets 52,54 having their poles arranged as indicated. Pole pieces 56a, 56b, 56c, 56d, 56e are shaped to form an air gap 58 which receives a cylindrical former 60 on which first and second voice coils 62,64 are wound. The pole pieces 56a, 56b, 56c, 56d, 56e are shaped to form upper and lower annular air gaps 66a, 66b and which extend inwardly from the air gap 58 back to the central magnet 50. The pole pieces 56a, 56b, 56c, 56d, 56e further form an outer central annular air gap 66c and upper and lower outer annular air gaps 66d, 66e as shown in FIG. 5. The cone 51 and housing 52 are not shown.

It should be noted it is preferred in the present invention for the axial length of the voice coil(s) and, when two or more coils are provided, their axial separation to be related to the spacing of the recesses in the walls of the air gap and/or spacing of the bands of material of reduced permeability in a simple mathematical manner. Thus, for example, the spacing of the coils on the former may be equal to the spacing between every two, three or four poles of the pole pieces. Other, more complex, mathematical relationships are also possible.

It has been shown that substantial reductions in second harmonic and third harmonic distortion can be achieved with the embodiments of the magnetic circuit shown in FIGS. 1 to 5. Taking the embodiment of FIG. 3 as an example, whereas with a conventional magnetic circuit one might achieve a reduction in the second harmonic distortion of −19 dB, with an accompanying increase in the third harmonic distortion of +3 dB, with the motor drive of FIG. 3 one can achieve a reduction in the second harmonic distortion of approximately −32 dB, with a reduction also in the third harmonic distortion of about −5 dB. One thus has a highly linear motor.

Although in each of the embodiments described above the pole piece assembly comprises four or more pole piece elements, it is to be understood that the invention covers also the use of two poles, three poles or more than four poles, with or without rings of conductive or non-conductive material. Thus, according to the present invention two or more poles are separated or divided in such a way that they are not in direct physical contact one with another and that the magnetic path between the poles has reduced permeability. It is only necessary that the two or more poles should be separated or divided in such a way that they are not in direct physical contact one with another and that the magnetic path between the poles should have minimum permeability.

Although the embodiments described above show magnetic structures which are arranged to provide cylindrical symmetry with respect to an annular air gap, with the symmetry being about the longitudinal axis of the loudspeaker, the invention is also applicable to the use of magnetic circuits which are not axially symmetrical in terms of the magnet geometry. A non-axisymmetric version has higher reluctance between the plates.

It is understood that the exemplary transducers described herein and shown in the drawings represent only presently preferred embodiments of the invention. Indeed, various modifications and additions may be made to such embodiments without departing from the spirit and scope of the invention. For example, the magnet/voice coil assembly may be non-symmetric rather than cylindrically symmetric, or may have a completely different symmetry or symmetries. Various applications other than use in an audio speaker are contemplated.

Thus, these and other modifications and additions may be obvious to those skilled in the art and may be implemented to adapt the present invention for use in a variety of different applications.

1. An electromechanical drive assembly, comprising:
a magnet structure which comprises at least one permanent magnet and is shaped to define an air gap; and
a cylindrical coil which is received in the gap and movable axially therein relative to the magnet structure, the coil comprising at least one coil winding;
wherein the material and/or the shape of the magnet structure is such that the path of the magnetic flux of the permanent magnet is split.

2. The assembly according to claim 1, wherein the surfaces of the magnet structure defining the gap are shaped so that the path of the magnetic flux of the permanent magnet is split in the region of the gap.

3. The assembly according to claim 1, wherein the material of the magnet structure defining the gap is chosen so that the path of the magnetic flux of the permanent magnet is split in the region of the gap.

4. The assembly according to claim 2, wherein the magnet structure has in at least one of its surfaces defining the air gap at least one annular recess which extends to the gap.

5. The assembly according to claim 3, wherein at least one of the surfaces of the magnet structure defining the air gap is formed from a material of reduced magnetic permeability relative to the remainder of the magnet structure.

6. The assembly according to claim 1, wherein the magnet structure comprises one or more permanent magnets and one or more pieces of ferromagnetic material.

7. The assembly according to claim 6, wherein the gap is defined entirely by the one or more pole pieces.

8. The assembly according to claim 6, wherein the gap is defined in part by the one or more pole pieces and in part by the one or more permanent magnets.

9. The assembly according to claim 6, wherein the one or more permanent magnets and/or the one or more pole pieces are shaped to define at least one annular recess in the magnet structure which extends to and merges with the air gap.

10. The assembly according to claim 9, in which the one or more pole pieces are shaped so that the at least one recess extends from the air gap to the permanent magnet.

11. The assembly according to claim 6, wherein the magnet structure comprises at least one piece of material of reduced magnetic permeability relative to the one or more pole pieces, the at least one piece of reduced permeability material being annular in shape and extending from the air gap, where it defines a portion of the surface thereof, to the one or more permanent magnets.

12. The assembly according to claim 1, wherein alternate annular portions of an inner surface of the air gap are formed from the magnet structure and from a material of reduced magnetic permeability relative to the remainder of the magnet structure.

13. The assembly according to claim 1, wherein alternate annular portions of an outer surface of the air gap are formed from the magnet structure and from a material of reduced magnetic permeability relative to the remainder of the magnet structure.

14. The assembly according to claim 12, wherein the annular portions of the inner surface are aligned across the gap with the annular portions of the outer surface.

15. The assembly according to claim 1, wherein the surface of the magnet structure defining an inner surface of the air gap is shaped so that the inner surface of the air gap is interrupted by a plurality of annular recesses which extend to and merge with the gap.

16. The assembly according to claim 1, wherein the surface of the magnet structure defining an outer surface of the air gap is shaped so that the outer surface of the air gap is interrupted by a plurality of annular recesses which extend to and merge with the gap.

17. The assembly according to claim 15, wherein the inner annular recesses are aligned across the gap with the outer annular recesses.

18. The assembly according to claim 1, wherein alternate annular portions of one of the inner and the outer surfaces of the air gap are formed from the magnet structure and from a material of reduced magnetic permeability relative to the remainder of the magnet structure and the surface of the magnet structure defining the other of the inner and the outer surface of the air gap is shaped so that the said other surface of the air gap is interrupted by a plurality of annular recesses which extend to and merge with the gap, the annular portions of reduced magnetic permeability being aligned across the gap with the annular recesses.

19. The assembly according to claim 12, wherein there are at least two said annular portions of reduced permeability.

20. The assembly according to claim 15, wherein there are at least four said annular recesses extending to and merging with the air gap.

21. The assembly according to claim 1, wherein the coil comprises a former on which are formed two or more axially-spaced coil windings.

22. The assembly according to claim 21, wherein the axial extent of the windings is less than the axial extent of the air gap.

23. The assembly according to claim 1, further comprising first and second permanent magnets which are spaced-apart in the axial direction of the air gap.

24. The assembly according to claim 1, further comprising first, second and third permanent magnets which are spaced-apart in the axial direction of the air gap.

25. The assembly according to claim 1, wherein the magnet structure and the coil are substantially cylindrically symmetric.

26. The assembly according to claim 1, wherein the magnet structure comprises a plurality of generally-conical pole pieces which are arranged about a common axis and nested within one another with air spaces therebetween, the outer edges of the pole pieces defining the inner wall of the air gap.

27. The assembly according to claim 1, wherein the air gap and the coil are each cylindrical.

28. A magnet and coil assembly comprising at least one magnetic circuit which is split so as to mitigate a permeability thereof.

29. A magnet and coil assembly comprising:
one or more magnets;
one or more coils; and
one or more magnetic circuits between the one or more magnets and the one or more voice coils, at least one of the magnetic circuits being split so as to mitigate a permeability thereof.

30. A loudspeaker comprising an assembly according to claim 29 and a cone which is attached to the coil.

31. (canceled)

32. The assembly according to claim 7, wherein the one or more permanent magnets and/or the one or more pole pieces are shaped to define at least one annular recess in the magnet structure which extends to and merges with the air gap.

33. The assembly according to claim 8, wherein the one or more permanent magnets and/or the one or more pole pieces are shaped to define at least one annular recess in the magnet structure which extends to and merges with the air gap.

34. The assembly according to claim 32, wherein the one or more pole pieces are shaped so that the at least one recess extends from the air gap to the permanent magnet.

35. The assembly according to claim 33, wherein the one or more pole pieces are shaped so that the at least one recess extends from the air gap to the permanent magnet.

36. The assembly according to claim 7, wherein the magnet structure comprises at least one piece of material of reduced magnetic permeability relative to the one or more pole pieces, the at least one piece of reduced permeability material being annular in shape and extending from the air gap, where it defines a portion of the surface thereof, to the one or more permanent magnets.

37. The assembly according to claim 8, wherein the magnet structure comprises at least one piece of material of reduced magnetic permeability relative to the one or more pole pieces, the at least one piece of reduced permeability material being annular in shape and extending from the air gap, where it defines a portion of the surface thereof, to the one or more permanent magnets.

38. The assembly according to claim 13, wherein the annular portions of the inner surfaces are aligned across the gap with the annular portions of the outer surface.

39. The assembly according to claim 16, wherein the inner annular recesses are aligned across the gap with the outer annular recesses.

40. The assembly according to claim 15, wherein there are at least two said annular recesses in each cylindrical wall of the air gap.

41. The assembly according to claim 16, wherein there are at least four said annular recesses extending to and merging with the air gap.
